(19) United States
(12) Patent Application Publication
(10) Pub. No.: US 2008/0231571 A1
(43) Pub. Date: Sep. 25, 2008

(54) Color Overdrive for Color Sequential Matrix-Type Display Devices

(75) Inventors: Marcellinus Petrus Carolus Michael Krijn, Eindhoven (NL); Franciscus Paulus Maria Budzelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,328

(22) PCT Filed: Sep. 25, 2006
(86) PCT No.: PCT/IB06/53480

§ 371 Date: Mar. 19, 2008

Related U.S. Application Data
(60) Provisional application No. 60/722,669, filed on Sep. 30, 2005.
(60) Provisional application No. 60/751,425, filed on Dec. 16, 2005.

(51) Int. Cl. G09G 3/36

(52) U.S. Cl. 345/87

(57) ABSTRACT

A method and apparatus for increasing the brightness of a color-sequential matrix display, in which the matrix display is addressed on a line-by-line basis, includes dividing a frame period of said matrix display into sub-fields corresponding to the number of light colors being used to sequentially illuminate said matrix display illuminating the display sequentially with said light colors, each for the duration of the corresponding sub-field, and pre-processing the video signal to compensate for errors due to illuminating the display during the addressing time and LC response time. The pre-processing includes determining a direction and an amount of gray scale level change from a preceding sub-field to a current sub-field, and increasing or decreasing the video signal in the current sub-field in dependence on the determined direction of the gray scale level change from the preceding sub-field and by an amount corresponding to a predetermined factor of said determined amount of gray scale level change.

The subject invention relates to a method for increasing the brightness of matrix-type display devices.

Recently, much progress has been made in increasing the brightness of light emitting diodes (LEDs). As a result, it is anticipated that in years to come, LEDs will become sufficiently bright and inexpensive to serve as a light source for matrix-type displays. This enables obtaining high quality video with a very large color gamut and a contrast higher than that obtainable using present technology. It also enables front projections displays for portable applications.

In displays that make use of line-at-a-time addressing, it is advisable not to illuminate the display panel during addressing, in that during addressing and the subsequent response time of the pixels, the state of the pixels is, in general, not clearly defined.

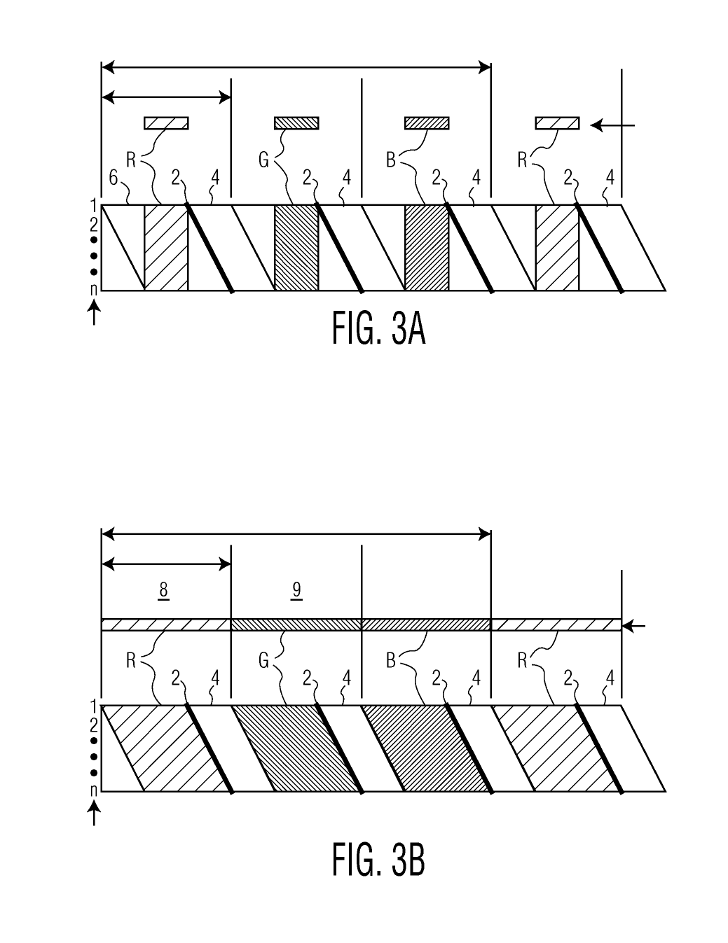

Addressing of a matrix-type display, e.g., LCOS or DMD, is done line-at-a-time. This technology is a good candidate for LED-based projection. In line-at-a-time addressing, each frame is divided into one or more fields. Each of these fields is then subdivided into three color fields, corresponding, respectively, to the colors red, green and blue. Starting at the beginning of a color field period, the first line is addressed by activating the appropriate row electrode. The pixels within this line are reset (optional) and subsequently addressed by supplying the correct voltages to the column electrodes in order to render the correct grey scale level. Next, the following line is addressed, and so on. The panel is fully addressed after addressing the last line, and after waiting until the response time of the liquid crystal (LC) material has passed. At this point in time, it is appropriate to switch on the LEDs corresponding to the color field that has been addressed. The LEDs remain switched on until the start of addressing of the next color field. This is shown in FIG. 3A.

However, light can only be generated for a limited amount of time. The line address time can be as small as 1 μsec per line. For XGA resolution (864 lines), the panel address time is, therefore, typically 1 msec. The LC response time is also of the order of 1 msec. In the case of color sequential operation with 3 color fields at 60 Hz frame rate, the field time is 1/60/3=5.56 msec. The sum of line address time and LC response time is 2 msec. This means that the effective duty cycle for illumination is only (5.56−2)/5.56/3=21% for each color. In other words, each color is allowed to be on for only 21% of the total time instead of the theoretical maximum of 33%. The problem is, therefore, that during almost 40% of the time no light can be generated.

It is an object of the present invention to increase the brightness in a matrix-type display.

This object is achieved in a method of increasing the brightness of a color-sequential matrix display, said matrix display being addressed on a line-by-line basis, said method comprising the steps of dividing a frame period of said matrix display into sub-fields corresponding to the number of light colors being used to sequentially illuminate said matrix display; addressing the pixels in each line of the display in each sub-field, said addressing comprising applying a video signal to each pixel in each line of the display in each sub-field, said video signal corresponding to a gray scale level of the video signal for the light color corresponding to the respective sub-field; allocating an LC response time for each line of the display in each sub-field; and illuminating the display sequentially with said light colors, each for the duration of the corresponding sub-field.

Applicants note that while the above method does increase the brightness, artifacts arise due to the illumination of the display elements during the addressing time and the LC response time. This is due to the gray scale level of the display element in the current sub-field being affected by the gray scale level of the display element due to the previous sub-field. This effect is shown in FIGS. 3A and 3B. In particular, FIG. 3A shows the case where the panel is illuminated by the color lights only after the whole of the addressing period and the LC response times for the whole panel. As graphically shown, the color lights R, G, B are only illuminated for a portion of each color sub-field, and as such, only a portion of duration of each line is subjected to the color light. The addressing periods are shown as the heavy dark lines 2; the LC response times are shown as the dark gray zones 4, while the light gray zones 6 indicate the idle times of each sub-field period. As compared with FIG. 3B, the color lights R, G, B are illuminated for each entire color sub-field. Hence, there are no idle times (light gray zones 6). However, during the latter part of, for example, the red color sub-field 8, the lines in the display panel are already being addressed for the ensuing green color sub-field, and the display elements are already changing over to the gray scale level of the ensuing green color sub-field 9. This leads to an incorrect total gray scale level for the red color sub-field 8.

To that end, the method of increasing the brightness further comprises the step of pre-processing the video signal to compensate for errors due to illuminating the display during the addressing time and LC response time, said pre-processing step including determining a direction and an amount of gray scale level change from a preceding sub-field to a current sub-field; and increasing or decreasing the video signal in the current sub-field in dependence on the determined direction of the gray scale level change from the preceding sub-field and by an amount corresponding to a predetermined factor of said determined amount of gray scale level change.

With the above and additional objects and advantages in mind as will hereinafter appear, the invention will be described with reference to the accompanying drawings, in which:

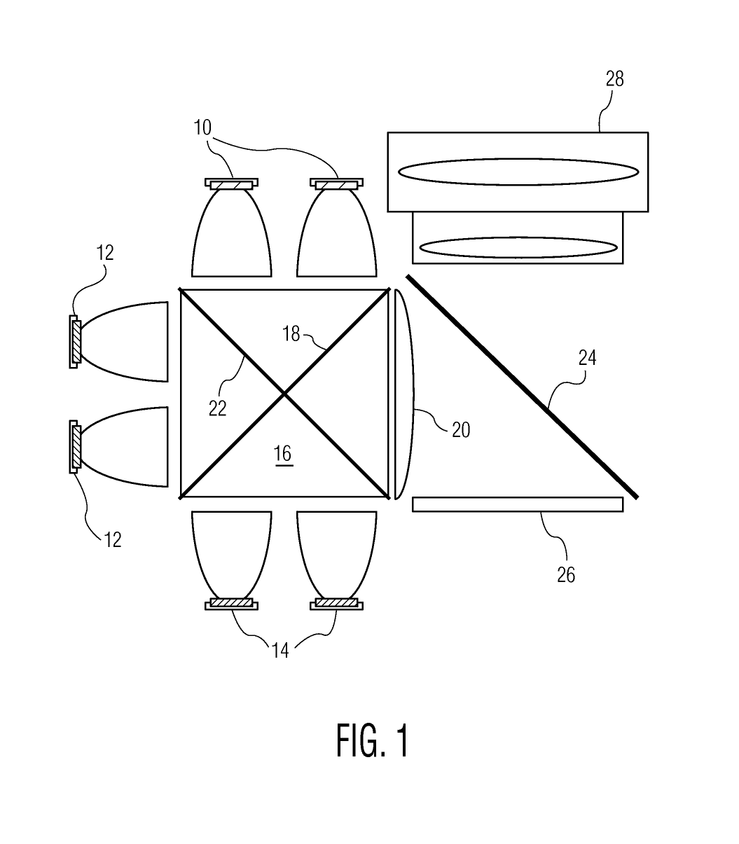

FIG. 1 shows a block diagram of the light engine in a single panel projection display;

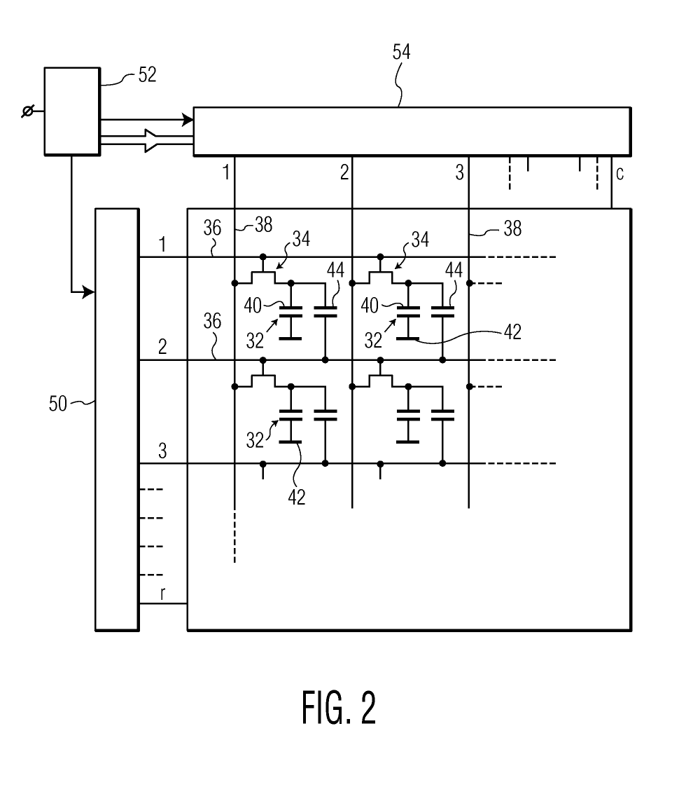

FIG. 2 shows a block schematic diagram of a matrix-type display panel;

FIG. 3A shows a diagram illustrating the typical lighting of a line-at-a-time addressed matrix-type panel, while FIG. 3B shows a diagram illustrating the lighting of the panel in accordance with the subject invention;

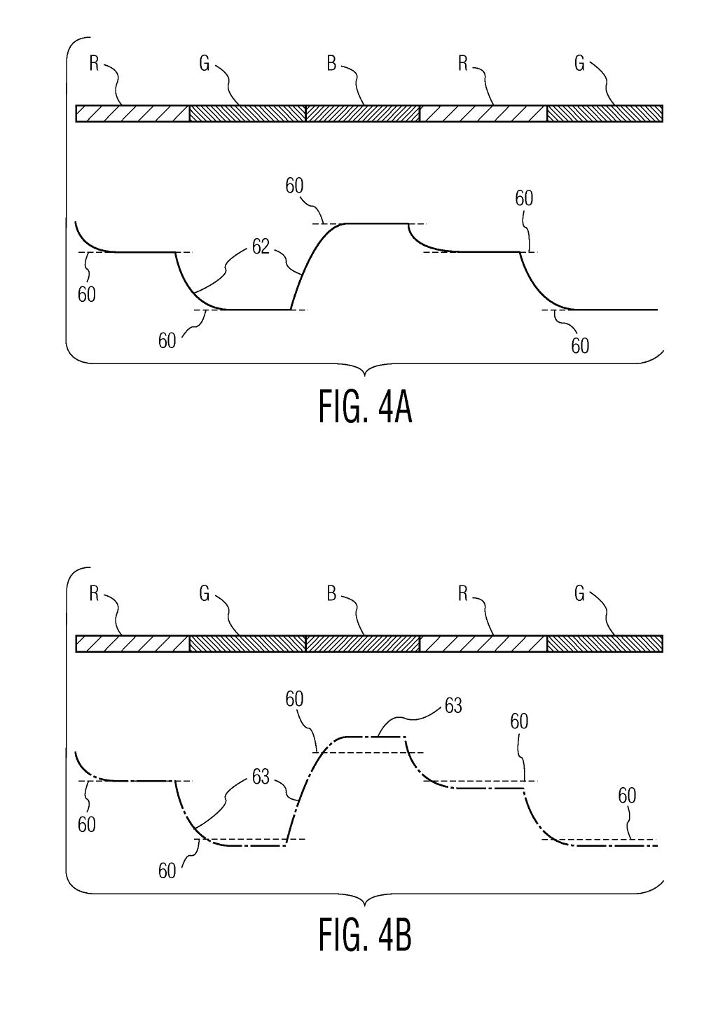

FIG. 4A shows the light generation of the subject invention when used with uncorrected video signals, while FIG. 4B shows the light generation of the subject invention when used with corrected video signals; and

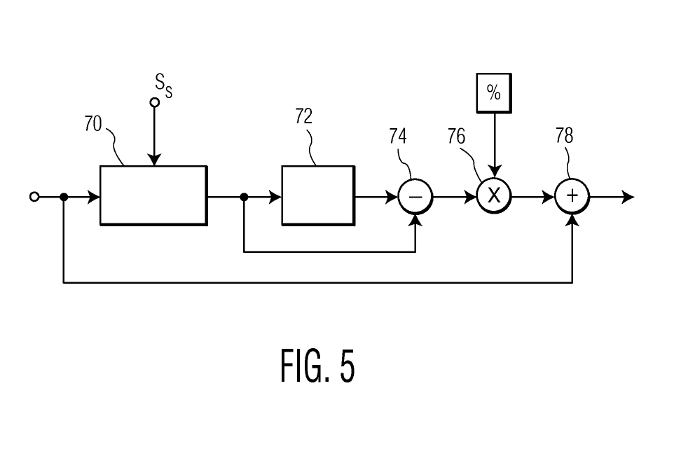

FIG. 5 shows a block schematic diagram of a circuit for pre-processing the video signal in accordance with the subject invention.

FIG. 1 shows a block diagram of the light engine in a single panel projection display. Light is provided by 3 sets of light emitting diodes (LEDs) 10, 12 and 14, selectively emitting the colors red, green and blue. The light from the red LEDs 10 is directed into light guide 16 and refracted by dichroic filter 22 to the field lens 20. Similarly, the light from blue LEDs 14 is directed into the light guide 16 and refracted by dichroic filter 18 to the field lens 20. Finally, light from the green LEDs 12 is directed into the light guide and is sent directly to the field lens 20. The light from the field lens 20 is refracted by PBS/reflective polarizer 24 to the matrix-type panel, which is shown as a reflective liquid crystal on silicone (LCOS) panel 26 for modulating the light with a video signal applied thereto. The modulated light signal then passes through the PBS/reflective polarizer 24 and is magnified by projection lenses 28 for focusing onto a projection screen (not shown).

In the embodiment shown in FIG. 1, the panel 26 is fully illuminated by each color in each sub-field. However, as an alternative, the panel 26 may be illuminated by successive stripes of lights, namely, a red stripe, a green stripe and a blue stripe. These stripes are scrolled across the panel in the vertical direction. This can be achieved by using a scanning backlight for each color separately. With this method, it is possible to reduce motion artifacts caused by an LC response that is too slow.

FIG. 2 shows a block schematic diagram of an LCD panel 30. The panel 30 includes a row and column array of display elements which consist of r rows (1 to r) with c horizontally arranged picture display elements (pixels) 32 (1 to c) in each row. Only a few of the display elements are shown for simplicity.

Each display element 32 is associated with a respective switching device in the form of a thin film transistor TFT 34. The gate terminals of all TFTs 34 associated with display elements in the same row are connected to a common row conductor 36 to which, in operation, selection pulse (gating) signals are supplied. Likewise, the source terminals of the TFTs 34 associated with all display elements in the same column are connected to a common column conductor 38 to which data (video) signals are applied. The drain terminals of the TFTs 34 are each connected to a respective transparent display element electrode 40 forming part of, and defining, the display element. The set of conductors 36 and 38, TFTs 34 and electrodes 40 are carried on one transparent plate, while a second, spaced, transparent plate carries an electrode 42 common to all display elements. Liquid crystal material is disposed between the plates and each display element comprises the electrode 40 and overlying portions of the liquid crystal layer and the common electrode 42. Each display element further includes a storage capacitor 44 which is connected between the display element electrode 40 and a row conductor 36 adjacent to that which the TFT 34 associated with the display element is connected.

In operation, light from a light source (e.g., field lens 20) enters the panel and is modulated according to the transmission characteristics of the display element 32. The panel 30 is driven on a row at a time basis by scanning the row conductors 36 sequentially with a selection pulse signal so as to turn on each row of TFTs in turn in a respective row addressing period, and applying data (video) signals to the column conductors 38 for each row of display element in turn as appropriate and in synchronism with gating signals so as to build up over one field a complete display picture. Using one row at a time addressing, all TFTs 34 of the addressed row are switched on for a period determined by the duration of the selection pulse signal, which corresponds to less than an applied video signal line period, during which the data information signals are transferred from the column conductors 38 to the display elements 32. Upon termination of the selection signal, the TFTs 32 of the row are turned off for the remainder of the field time thereby isolating the display elements from the conductors 38 and ensuring the applied charge is stored on the display elements until the next time they are addressed, usually the next field period.

The row conductors 36 are supplied successively with selection pulse signals by a row drive circuit 50 comprising a digital shift register controlled by regular timing pulses from a processor 52. For a major part of the intervals between selection signals, the row conductors 36 are supplied with a substantially constant reference potential, e.g., zero volts, by the row drive circuit 50 to hold the TFTs 34 in their off state. Video information signals are supplied to the column conductors 38 from a column drive circuit 54 of conventional form comprising one or more shift register/sample-and-hold circuits. The column drive circuit 54 is supplied with video signals and timing pulses from the processor 52 in synchronism with row scanning to provide serial to parallel conversion appropriate to the row at a time addressing of the panel.

The processor 52 controls the sets of LEDs 12, 14 and 16 to be illuminated during the whole of the respective color sub-fields. In order to compensate for artifacts that occur due to the inappropriate gray scale level caused by the changing of the gray scale level for the previous color, the processor 52 pre-processes the video signal. In particular, the processor 52 measures a first determined difference and a first direction of the change in the gray scale level for the preceding color to the current color. Then if first direction is an increase in the gray scale level, the processor increases the gray scale level for the current color by an amount which is a first predetermined factor of the first determined difference. Alternatively, if the first direction is a decrease in the gray scale level, the processor 52 decreases the gray scale level for the current color by an amount which is a second predetermined factor of the first determined difference. In a preferred embodiment, the first and second predetermined factors are predetermined percentages of the first determined difference. This is shown in FIGS. 4A and 4B, where FIG. 4A shows the desired gray scale level as dotted lines 60 and the response 62 of the display elements due to the uncorrected video signal, while FIG. 4B shows the desired gray scale levels 60 and the response 63 of the display elements due to the corrected video signal. It should be understood that the pre-processing of the video signal is performed on the pixel level, i.e., the correction on the gray scale value can differ for each pixel, depending on the gray scale value of this pixel in the previous sub-field and the current sub-field.

FIG. 5 shows an embodiment of circuitry included in the processor 52 for pre-processing the video signal as applied to the column conductors 38. The video signal is applied to a sample-and-hold circuit 70 which receives a sub-field timing signal S_{S}. An output from the sample-and-hold circuit 70 is applied to a delay circuit 72 having a delay equal to the duration of a color sub-field. An output from the delay circuit 72 is applied to one input of a subtracting circuit 74 while the output of the sample-and-hold circuit 70 is applied to a second input of the subtracting circuit 74. An output of the subtracting circuit 74 carrying a difference signal is connected to a multiplying circuit 76 which multiplies the difference by a predetermined percentage, e.g., 5%. An adding circuit 78 adds the output from the multiplying circuit 76 to the input video signal.

In the above embodiment of the invention, due to the correction algorithm, the gray level can become less than zero or more than a maximum allowable value. These conditions should be avoided by the use of, for example, clipping.

The above embodiment of the invention considers only the effect of the preceding sub-field gray scale level on the current sub-field gray scale level. However, the gray scale level of the ensuing sub-field may also be taken into consideration. In particular, a second direction and a second difference may be determined between the gray scale level of the current sub-field and the gray scale level of the ensuing sub-field. Then the gray scale level of the current sub-field is increased or decreased based on a predetermined factor of a combination of the first and second directions and the first and second determined differences.

It should be noted that color-sequential direct view LCD's can be realized on a fast LC effect, such as the optically compensated bend (OCB) effect. The correction algorithm of the subject invention is particularly applicable to these types of LCD displays.

While the above description is based on the use of LED's as the light source, it should be understood that other light sources are applicable, e.g., fluorescent lamps.

In addition to the above-described correction algorithm, the duration of the sub-fields may be varied for the different colors depending on the image content. For example, if a certain picture to be displayed is predominantly green, then the duration of the green sub-field may be prolonged at the expense of the duration of the red and blue sub-fields. This further increases the brightness of the display.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method of increasing the brightness of a color-sequential matrix display (26), said matrix display being addressed on a line-by-line basis, said method comprising the steps of:
dividing a frame period of said matrix display (26) into sub-fields corresponding to the number of light colors being used to sequentially illuminate said matrix display;
addressing (2) the pixels (32) in each line of the display (26) in each sub-field, said addressing comprising applying a video signal to each pixel in each line of the display in each sub-field, said video signal corresponding to a gray scale level of the video signal for the light color corresponding to the respective sub-field;
allocating (4) an LC response time for each line of the display (26) in each sub-field;
illuminating (10, 12, 14, 16, 18, 20, 22, 24, 52) the display (26) sequentially with said light colors, each for the duration of the corresponding sub-field; and
pre-processing (52) the video signal to compensate for errors due to illuminating the display during the addressing time and LC response time.

2. The method as claimed in claim 1, wherein said pre-processing step comprises the sub-steps of:
determining (70, 72, 74) a direction and an amount of gray scale level change from a preceding sub-field to a current sub-field; and
increasing or decreasing (78) the video signal in the current sub-field in dependence on the determined direction of the gray scale level change from the preceding sub-field and by an amount corresponding to a predetermined factor (76) of said determined amount of gray scale level change.

3. The method as claimed in claim 1, wherein said pre-processing step comprises the sub-steps of:
determining (70, 72, 74) a first direction and a first amount of gray scale level change from a preceding sub-field to a current sub-field;
determining (52) a second direction and a second amount of gray scale level change from a current sub-field to an ensuing sub-field; and
increasing or decreasing (52) the video signal in the current sub-field in dependence on the determined directions of the gray scale level changes from the preceding sub-field as well as to the ensuing sub-field and by an amount corresponding to the sum of a predetermined factor of said first and second determined amounts.

4. The method as claimed in claim 1, wherein said illuminating step comprises illuminating the display with light colors corresponding to the basic colors red, green and blue, and said frame is divided into 3 sub-field periods.

5. The method as claimed in claim 2, wherein said predetermined factor is a predetermined percentage of said determined amount.

6. The method as claimed in claim 2, wherein said step of increasing or decreasing the video signal in the current sub-field corresponds, respectively, to a determined increase or decrease from the gray scale level of the preceding sub-field.

7. The method as claimed in claim 3, wherein said predetermined factor is a predetermined percentage of said determined amount.

8. The method as claimed in claim 3, wherein said step of increasing or decreasing the video signal in the current sub-field corresponds, respectively, to a determined increase or decrease from the gray scale level of the preceding sub-field.

9. An apparatus for increasing the brightness of a color-sequential matrix display (26), said matrix display (26) being addressed on a line-by-line basis, said apparatus comprising:
means for dividing a frame period of said matrix display (26) into sub-fields corresponding to the number of light colors being used to sequentially illuminate said matrix display;
means (2, 52) for addressing the pixels in each line of the display (26) in each sub-field, said addressing means applying a video signal to each pixel in each line of the display in each sub-field, said video signal corresponding to a gray scale level of the video signal for the light color corresponding to the respective sub-field;
means for allocating an LC response time (4) for each line of the display (26) in each sub-field;
means (10, 12, 14, 16, 18, 20, 22, 24, 52) for illuminating the display (26) sequentially with said light colors, each for the duration of the corresponding sub-field; and
a circuit (52, 70, 72, 74, 76, 78) for pre-processing the video signal to compensate for errors due to illuminating the display (26) during the addressing time and LC response time.

10. The apparatus as claimed in claim 9, wherein said pre-processing circuit comprises:
a delay circuit (72) having a delay of one sub-field, said delay circuit being coupled to receive said video signal;
a difference circuit (74) having a first input coupled to an input of said delay circuit (72) and a second input coupled to an output of said delay circuit (72), said difference circuit (74) determining a direction and an amount of gray scale level change from a preceding sub-field to a current sub-field;
a multiplying circuit (76) for multiplying an output of said difference circuit (74) by a predetermined factor; and
an adding circuit (78) having a first input coupled to the input of said delay circuit (72) and a second input coupled to an output of said multiplying circuit (76), whereby, depending on the sign of the output of the multiplying circuit (76), the video signal is increased or decreased in the current sub-field in dependence on the determined direction of the gray scale level change from the preceding sub-field and by an amount corresponding to the predetermined factor of said determined amount of gray scale level change.

11. The apparatus as claimed in claim 9, wherein said pre-processing circuit comprises:
means (74) for determining a first direction and a first amount of gray scale level change from a preceding sub-field to a current sub-field;
means (52) for determining a second direction and a second amount of gray scale level change from a current sub-field to an ensuing sub-field; and
means (52) for increasing or decreasing the video signal in the current sub-field in dependence on the determined directions of the gray scale level changes from the preceding sub-field as well as to the ensuing sub-field and by an amount corresponding to the sum of a predetermined factor of said first and second determined amounts.

12. The apparatus as claimed in claim 9, wherein the display (26) is illuminated with light colors corresponding to the basic colors red, green and blue, and dividing means divides said frame into 3 sub-field periods.
